(19) United States
(12) Patent Application Publication
(10) Pub. No.: US 2007/0024979 A1
(43) Pub. Date: Feb. 1, 2007

(54) Beam-forming device

(76) Inventors: Vitalij Lissotschenko, Frondenberg (DE); Aleksel Mikhailov, Dortmund (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 10/564,883

(22) PCT Filed: Jul. 29, 2004
(86) PCT No.: PCT/EP04/08500

§ 371 Date: Jun. 16, 2006

(30) Foreign Application Priority Data
Aug. 1, 2003 (DE) 103 35 271.6

(51) Int. Cl. G02B 27/10

(52) U.S. Cl. 359/619

(57) ABSTRACT

The invention relates to methods for producing an optical beam forming device including a plurality of lens means on at least one optically functional boundary surface, said lens means being disposed in an offset manner relative to each other in at least one direction. Said beam-forming device is composed of at least two optically functional components each of which is provided with at least one first cylindrical lens means on a first optically functional boundary surface while being provided with at least one second cylindrical lens means on a second optically functional boundary surface that lies essentially across from the first optically functional boundary surface. The cylinder axis means extends substantially perpendicular to the cylinder axis of the first cylindrical lens means located on the first boundary surface.

### BACKGROUND OF THE INVENTION

This invention relates to a process for producing an optical beam forming device which has a plurality of lens means which are arranged offset to one another in at least one direction on at least one optically functional interface.

Optical beam forming devices are arrangements of optically functional components which are suited to selectively modify the radiation characteristic of a beam bundle in order to obtain, for example, a defined shape and an intensity distribution which is defined over the cross section of the beam bundle. Here it is often advantageous to arrange the optically functional components in packing as dense as possible in order to achieve the aforementioned objectives. For example, arranging spherical lenses hexagonally to one another to obtain a comparatively high bulk density (packing density) of the lenses is known.

WO 98/10314 discloses forming individual lenses which can be made spherical, aspherical and/or cylindrical, convex or concave and which moreover can also have different focal lengths and/or apertures, in the manner of facets rotationally symmetrical on a spherical-convex base surface. But production of such an arrangement is relatively complex and expensive.

It is an object of this invention is to make available a process for producing an optical beam forming device of the initially mentioned type and a generic optical beam forming device which can be produced more economically.

### SUMMARY OF THE INVENTION

It is proposed that the beam forming device is assembled from at least two optically functional modules, each of the at least two optically functional modules on a first optically functional interface having at least one first cylinder lens means and on the second interface which is essentially opposite the first at least one second cylinder lens means with a cylinder axis which is aligned essentially perpendicular to the cylinder axis of the cylinder lens means which is located on the first interface. The at least two optically functional modules are joined such that on the optically functional interface of the beam forming device there are cylinder lens means arranged offset to one another in one direction. The cylinder lens means are then arranged more or less in a facet-like manner on this interface of the beam forming device. The term cylinder lens means here is defined as lens means with cylinder geometry and moreover also lens means with a cylinder-like geometry.

In one preferred embodiment at least two optically functional modules are assembled such that the cylinder axes of the first cylinder lens means are oriented at least partially parallel to one another on a first optically functional interface of the beam forming device. Furthermore at least two optically functional modules are assembled such that the cylinder axes of the second cylinder lens means are oriented at least partially parallel to one another on a second optically functional interface of the beam forming device. In this way better optical properties of the beam forming device are obtained.

In one especially preferred embodiment at least two optically functional modules of at least one cylinder lens array with a plurality of first cylinder lens means on the first side and a plurality of second cylinder lens means on a second side opposite the first side are cut. In this embodiment the at least two optically functional modules can be produced in an especially simple manner from the cylinder lens array.

In one preferred embodiment it is provided that the cylinder lens array is cut by planes which are oriented essentially parallel to the lengthwise axes of the first cylinder lens means. For reasons of symmetry, in one especially preferred embodiment the cylinder lens array is cut by planes which extend through the joint edges of adjacent first cylinder lens means and which orthogonally intersect the cylinder axes of the second cylinder lens means.

In one especially advantageous embodiment it is provided that the lengthwise sides of the optically functional modules are contoured at least in sections by segments being cut out of the lengthwise sides. In this way joining of at least two optically functional modules is simplified.

In one especially preferred embodiment it is provided that the lengthwise sides are contoured at least in sections such that the joining of at least two optically functional modules takes place such that the cylinder lens means are located offset to one another in at least one direction.

For reasons of symmetry and in order to facilitate joining of the optically functional modules, it is advantageous that segments of roughly the same size are cut out of the lengthwise sides of the optically functional modules.

In one especially preferred embodiment segments with cross sections which have an essentially triangular outline are cut out of the lengthwise sides of the optically functional modules. In this way the lengthwise sides of the optically functional modules acquire a type of zig-zag contouring.

Advantageously identical segments are cut out of the two opposing lengthwise sides of the optically functional modules opposite one another in order to reduce the effort for later joining.

The optically functional modules can be joined in such a way that on one interface of the beam forming device an essentially hexagonally packed arrangement of the second cylinder lens means is formed.

It has been found that the cylinder lens array can be easily cut and contoured by means of ultrasound, electron beams or laser beams. These production steps can also be carried out with computer support in order to obtain an optimum cutting and contouring result.

In order to permanently stabilize the arrangement of the individual optically functional modules after joining, it has been found to be advantageous for the optically functional modules to be cemented to one another at least in sections. Alternatively they can also be soldered to one another.

The beam forming device comprises preferably cylinder lens means which are shaped convexly and/or concavely and which have spherical and/or aspherical jacket surfaces.

The lens means can be arranged essentially hexagonally tightly packed on at least one optically functional interface of the beam forming device.

The outer contour of the beam forming device can be adapted to different applications and can be for example essentially round, rectangular, square or hexagonal.

The beam forming device is preferably made up of glass, especially of silica glass, or of plastic.

### BRIEF DESCRIPTION OF THE DRAWINGS

Other features and advantages of this invention will become clear based on the following description of one preferred embodiment with reference to the attached figures.

FIG. 1 shows a perspective extract of an orthogonally crossed cylinder lens array from which a beam forming device is produced as claimed in the invention;

FIG. 2 shows a perspective view of an optically functional module;

FIG. 3 shows a perspective view of the beam forming device; and

FIG. 4 shows a perspective view of the beam forming device turned by 1800.

### DETAILED DESCRIPTION OF THE INVENTION

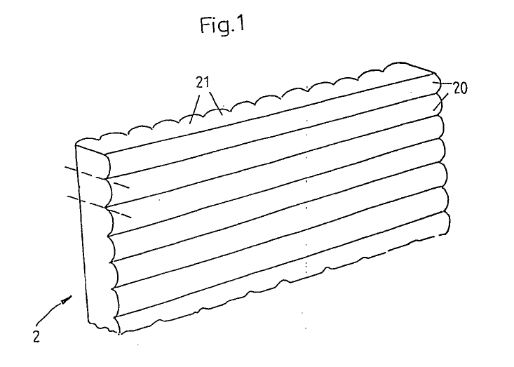

First, reference is made to FIG. 1. It shows in perspective an extract of an orthogonally crossed cylinder lens array 2 from which a beam forming device is produced according to the process as claimed in the invention.

It is apparent that the cylinder lens array 2 on the front, i.e. on the side facing the viewer, has a plurality of first cylinder lens means 20 with lengthwise axes which are oriented essentially parallel to one another. The first cylinder lens means 20 each have curved jacket surfaces, the termination of which forms joint edges of adjacent first cylinder lens means 20.

On its back the cylinder lens array 2 has a plurality of second cylinder lens means 21 with lengthwise axes which are likewise oriented essentially parallel to one another. The second cylinder lens means 21 likewise have curved jacket surfaces, the termination of which forms joint edges between adjacent second cylinder lens means 21.

The lengthwise axes (cylinder axes) of the first cylinder lens means 20 on the front are recognizable essentially perpendicular to the lengthwise axes of the second cylinder lens means 21 on the back of the cylinder lens array 2.

Such a cylinder lens array 2, as is shown in FIG. 1, forms the initial material for producing the beam forming device 1 using the process as claimed in the invention. In the embodiment shown here all the first and second cylinder lens means 20, 21 of the orthogonally crossed cylinder lens array 2 are made convex. It is of course also possible for the first and/or the second cylinder lens means 20, 21 to be at least partially concave. Generally such a cylinder lens array 2 is made of glass, especially silica glass. In the meantime it is also possible to produce cylinder lens arrays from plastic.

As set forth in the invention the cylinder lens array 2 is first repeatedly cut axially parallel to the lengthwise axes of the first cylinder lens means 20 of the cylinder lens array 2 in order in this way to obtain a plurality of optically functional modules 30, 31, 32, 33 which will be detailed later with reference to the other figures. The cutting planes, therefore the planes along which the cylinder lens array 2 is cut, are oriented essentially parallel to the lengthwise axes of the first cylinder lens means 20 on the front and essentially perpendicular to the lengthwise axes of the second cylinder lens means 21 on the back of the cylinder lens array 2.

Here the individual cutting planes for reasons of symmetry each extend through the joint edges of two adjacent jacket surfaces of the first cylinder lens means 20 on the front of the cylinder lens array 2. The cylinder lens array 2 is cut preferably by means of ultrasound, electron beams or using lasers, especially UV lasers.

In this way optically functional modules 30, 31, 32, 33 are obtained which on the first side have an individual first cylinder lens means 20 and on the second side which is opposite the first side a plurality of second cylinder lens means 21.

At least two of these optically functional modules 30, 31, 32, 33 are joined in a next step into the beam forming device 1, the second cylinder lens means 21 on one interface of the beam forming device 1 being arranged offset to one another in a facet-like manner.

In order to simplify the joining of the optically functional modules 30, 31, 32, 33 and on one interface of the beam forming device 1 to obtain the aforementioned facet-like arrangement of the second cylinder lens means 21, two lengthwise sides of the optically functional modules 30, 31, 32, 33 at a time are contoured with a zig-zag structure. Viewed in the lengthwise direction segments are continuously cut out of the side edges of each optically functional module 30, 31, 32, 33. The individual segments are preferably of the same size and have a cross section with an essentially triangular outline. The segments can in turn be cut out preferably by means of ultrasound or using lasers, especially UV lasers or electron beams.

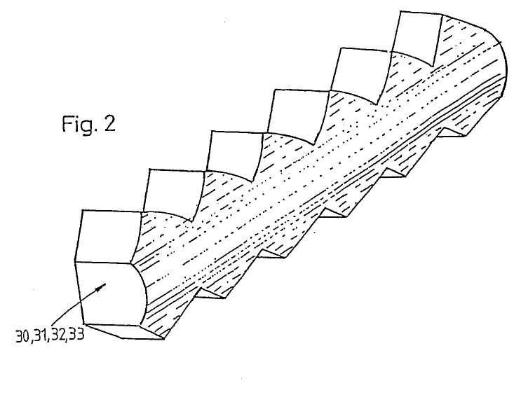

FIG. 2 shows by way of example an optically functional module 30, 31, 32, 33 which has been cut out of the cylinder lens array 2 and from the side edges of which identical segments with roughly triangular outlines have been continuously cut in order in this way to obtain zig-zag structures. It is apparent that these zig-zag structures are present identically in the area of both side edges, opposite one another. This property of the optically functional module 30, 31, 32, 33 which has been produced in this way simplifies the joining of several of these modules.

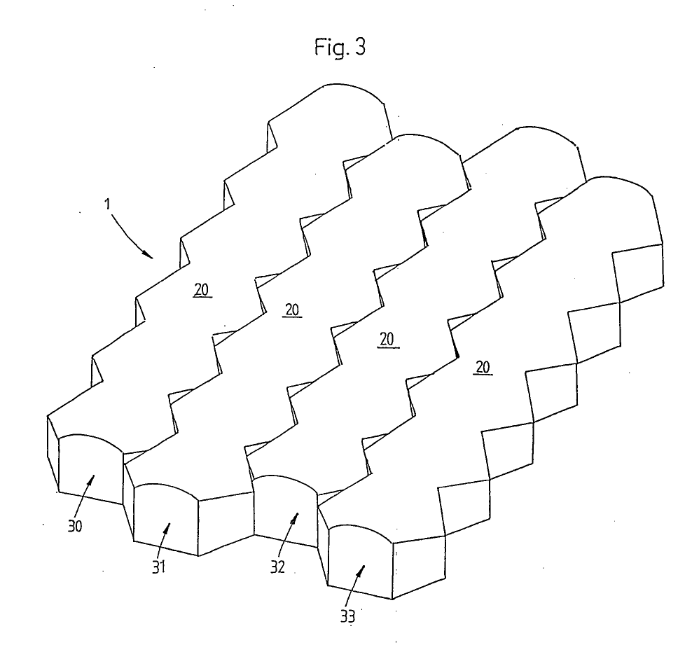

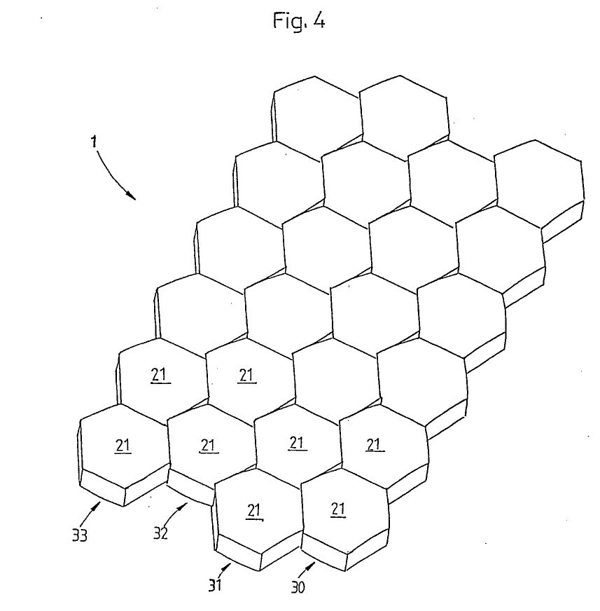

After the optically functional modules 30, 31, 32, 33 have been contoured, as just described, they can be assembled into the beam forming device 1 as shown in FIG. 3 and FIG. 4.

A beam forming device 1 which has been assembled from four optically functional modules 30, 31, 32, 33 is shown in perspective in FIG. 3 and FIG. 4. The directions of looking at it have each been turned 180° to one another.

FIG. 3 clearly shows that the lengthwise axes of the first cylinder lens means 20 of the four optically functional modules 30, 31, 32, 33 extend essentially parallel to one another even after joining. Furthermore the curvature of the first cylinder lens means 20 on the second interface of the beam forming device 1 shown here is apparent. The areas of the side edges of adjacent optically functional modules 30, 31, 32, 33 which have not been contoured as described above project into the areas from which the segments have been cut out. It thus becomes clear that the zig-zag structuring of the two side edges simplifies the joining of the optically functional modules 30, 31, 32, 33.

The optically functional modules 30, 31, 32, 33 can be cemented or soldered at least in sections in order to form a stable and permanent combination.

FIG. 4 shows the beam forming device 1 which has been produced according to the process as claimed in the invention from a second side. This view is therefore turned by 180° to that from FIG. 3. This representation illustrates the facet-like, offset arrangement of the two cylinder lens means 21 on the second interface of the beam forming device 1. This means that roughly in the area of one joint edge of two axially successive cylinder lens means 21 of a first optically functional module 30, 31, 32, 33 the jacket surfaces of the second cylinder lens means 21 of an adjacent optically functional module 30, 31, 32, 33 run straight through their vertex.

Altogether the beam forming device 1 which has been produced according to the process as claimed in the invention has a high filling factor. The second lens means 21 on the second interface of the beam forming device 1 are packed relatively tightly, essentially hexagonally.

It should be explained once again at this point that the outer contour of the beam forming device 1 is optional. For example, rectangular, square, hexagonal, or also essentially circular outer contours can be produced.

Compared to the process for producing a densely packed lens arrangement which is known from the prior art, the process as claimed in the invention is relatively economical since the cylinder lens arrays 2 which are used as the initial materials can be produced in series.

What is claimed is:

1. A process for producing an optical beam forming device (4) which has a plurality of lens means which are arranged offset to one another in at least one direction on at least one optically functional interface, wherein the beam forming device 4 is assembled from at least two optically functional modules, each of the at least two optically functional modules on a first optically functional interface having at least one first cylinder lens means and on the second optically functional interface which is essentially opposite the first at least one second cylinder lens means with a cylinder axis which is aligned essentially perpendicular to the cylinder axis of the first cylinder lens means which is located on the first interface.

2. The process as claimed in claim 1, wherein at least two optically functional modules are assembled such that the cylinder axes of the first cylinder lens means are oriented at least partially parallel to one another on a first optically functional interface of the beam forming device.

3. The process as claimed in claim 1, wherein at least two optically functional modules are assembled such that the cylinder axes of the second cylinder lens means are oriented at least partially parallel to one another on a second optically functional interface of the beam forming device.

4. The process as claimed in claim 1 wherein at least two optically functional modules of at least one cylinder lens array with a plurality of first cylinder lens means on the first side and a plurality of second cylinder lens means on a second side opposite the first are cut.

5. The process as claimed in claim 4, wherein the cylinder lens array is cut by planes which are oriented essentially parallel to the lengthwise axes of the first cylinder lens means.

6. The process as claimed in claim 4, wherein the cylinder lens array is cut by planes which extend through the joint edges of adjacent first cylinder lens means and which orthogonally intersect the cylinder axes of the second cylinder lens means.

7. The process as claimed in claim 1, wherein lengthwise sides of the optically functional modules are contoured at least in sections by segments being cut out of the lengthwise sides.

8. The process as claimed in claim 7, wherein the lengthwise sides are contoured at least in sections such that the joining of at least two optically functional modules takes place such that the second cylinder lens means are located offset to one another at least in one direction.

9. The process as claimed in claim 7, wherein segments of the same size are cut out of the lengthwise sides of the optically functional modules.

10. The process as claimed in claim 7, wherein segments with cross sections which have an essentially triangular outline are cut out of the lengthwise sides of the optically functional modules.

11. The process as claimed in claim 1, wherein the optically functional modules are joined in such a way that on the second interface of the beam forming device an essentially hexagonally packed arrangement of the second cylinder lens means is formed.

12. The process as claimed in claim 1, wherein the optically functional modules are cut out of the cylinder lens array and contoured by means of ultrasound.

13. (canceled)

14. (canceled)

15. The process as claimed in claim 1, wherein the optically functional modules are cemented to one another at least in sections.

16. The process as claimed in claim 1, wherein the optically functional modules are soldered to one another at least in sections.

17. A beam forming device which has a plurality of lens means which are arranged offset to one another in at least one direction on at least one optically functional interface, wherein the beam forming device is produced by means of a process as claimed in claim 1.

18. The beam forming device as claimed in claim 17, wherein the beam forming device comprises cylinder lens means which are shaped convexly and/or concavely and which have spherical and/or aspherical jacket surfaces.

19. The beam forming device as claimed in claim 17, wherein the lens means are arranged essentially hexagonally tightly packed on at least one optically functional interface of the beam forming device.

20. The beam forming device as claimed in claim 1, wherein the outer contour of the beam forming device is essentially round, rectangular, square or hexagonal.

21. The beam forming device as claimed in claim 1, wherein the beam forming device consists of glass, silica glass, or plastic.
